(19) United States
(12) Patent Application Publication
(10) Pub. No.: US 2006/0109682 A1
(43) Pub. Date: May 25, 2006

(54) Light excitation-diffusion sheet for backlight unit and backlight unit for liquid crystal display using the same

(75) Inventors: Youngwook Ko, Seo-gu (KR); Namheon Lee, Daeduk-gu (KR); Youngju Ahn, Aansan-si (KR)

Correspondence Address: JENKENS & GILCHRIST, P.C., 901 15TH STREET N.W., SUITE 900, WASHINGTON, DC, 20005, US

(73) Assignee: KoDiTech Co., LTD, Daeduk-Gu (KR)

(21) Appl. No.: 11/027,119

(22) Filed: Dec. 30, 2004

(30) Foreign Application Priority Data
Nov. 22, 2004 (KR) 2004-95577
Dec. 24, 2004 (KR) 2004-111677

(51) Int. Cl. G02B 6/00

(52) U.S. Cl. 362/607; 362/613; 362/620

(57) ABSTRACT

A light excitation diffusion sheet for a backlight unit adapted to absorb a portion of light emitted from a light source of a blue wavelength or a mixed wavelength of a blue wavelength and at least one other wavelength, to emit light at different wavelengths from the light emitted from the light source, and to allow the rest of the light emitted from the light source to penetrate the sheet The light excitation-diffusion sheet comprises a light-exciting material exciting and amplifying the light from the light source and a light-diffusing material scattering and diffusing the light from the light source. The light-exciting material and the light-diffusing material are uniformly distributed in the light excitation-diffusion sheet The use of the light excitation-diffusion sheet enables production of edge light type and direct light type backlight units having diffusion and prism functions, good color purity and improved light efficiency at reduced costs.

### FIELD OF THE INVENTION

The present invention relates to a backlight unit for use in a liquid crystal display (LCD), and more particularly to a backlight unit for a liquid crystal display with improved color reproducibility which can be produced by using a novel diffusion sheet at reduced costs

### BACKGROUND OF THE INVENTION

Generally, a liquid crystal display does not emit light of its own to display images, but is a non-emissive display using external incident light beams to provide images. Therefore, no image can be observed from a liquid crystal display in a dark place without a light source. A backlight unit arranged in the back side of a liquid crystal display irradiates light to a LCD panel to display images in a dark place. Such a backlight unit is currently used in non-emissive displays, e.g., liquid crystal displays, and planar light source devices, e.g., illuminating signboards.

Backlight units are classified into direct light type units and edge light type units, in terms of the position of light sources. According to the direct light type units, light emitted from a plurality of light sources is directly irritated to a liquid crystal panel. According to edge light type units, a light source attached to the side wall of a light guide panel emits light, and the emitted light is transmitted to a liquid crystal panel. On the other hand, light sources for backlight units are generally divided into inorganic light emitting diodes and fluorescent lamps. In terms of the location of electrodes, the fluorescent lamps are further subdivided into cold cathode fluorescent lamps (CCFLs) wherein both terminal electrodes are located inside a tube and external electrode fluorescent lamps (EEFLs) wherein both terminal electrodes are located outside a tube.

FIG. 1 is a cross-sectional view schematically showing the structure of a conventional edge light type backlight unit for a liquid crystal display. Referring to FIG. 1, the backlight unit comprises an edge light type light source 11, a light guide panel 12 for guiding light emitted from the light source 11, a reflection plate 13 disposed under the light guide panel 12, a diffusion sheet 14 disposed on the light guide panel 12, two prism sheets 15 disposed on the diffusion sheet 14 in directions perpendicular and parallel to the diffusion sheet 14, respectively, and a protective sheet 16 disposed on the prism sheets 15. A light source cover 11a surrounds the light source 11 disposed at the outside of the backlight unit.

FIG. 2 is a cross-sectional view schematically showing the structure of a conventional direct light type backlight unit As shown in FIG. 2, the backlight unit comprises a plurality of light sources 21 arranged at predetermined intervals, a plurality of reflection plates 22 disposed below the respective light sources 21, a protective plate(not shown) disposed under the reflection plates 22, a diffusion sheet 24 disposed over the light sources 21, two prism sheets 25 disposed on the diffusion sheet 24, and a protective sheet 26.

The operational principle of the backlight units shown in FIGS. 1 and 2 will be described below. First, an alternating current power is supplied to the light source 11 or the plurality of light sources 21 to cause an electric discharge between electrodes and produce a discharge gas. UV rays generated from the discharge gas excite a fluorescent material to convert the UV rays to visible rays. The converted light is guided into the light guide panel 12 and is reflected from the reflection plate 13 (FIG. 1), or is partially reflected from the reflection plates 22 without passing through the light guide panel 12 (FIG. 2). Thereafter, the reflected light is diffused by the diffusion sheet 14 or 24, and is then irradiated into a liquid crystal panel via the prism sheets 15 or 25. A white inorganic light emitting diode or a cold cathode fluorescent lamp is mainly used as the light source 11 of the edge light type backlight unit (FIG. 1), and cold cathode fluorescent lamps or external electrode fluorescent lamps are mainly used as the light sources 21 of the direct light type backlight unit (FIG. 2).

The white inorganic light emitting diode emits white light from a combination of blue light emitted from a light emitting diode chip, which is a nitride-based semiconductor device, and yellow light emitted from a yttrium-aluminum-garnet (hereinafter, referred to as an “YAG”) fluorescent material, which absorbs and excites a portion of the blue light, coated on the semiconductor device. However, since yellow light emitted from the YAG-based fluorescent material is combined with blue light, which is complementary to yellow light, to emit white light, a portion of red light is missing and thus the realizaton of complete white light becomes difficult. A problem of the white inorganic light emitting diode is that since a large quantity of fluorescent materials are concentrated inside a reflection cup of a lead terminal having a very small area and most of the fluorescent materials are concentrated around an inorganic light emitting diode chip, the transmittance of blue light is low, rendering the realization of sufficient white light to satisfy consumers' needs difficult, and the luminance of the device per se is poor. Further, since the fluorescent material is-randomly distributed inside a molding part, the color of the emitted light varies according to viewing angles of the light emitting device. Moreover, since increased output of the inorganic light emitting diode chip generates an excessive amount of heat, the fluorescent material is deteriorated, resulting in low luminance and reliability of the light emitting device. For these reasons, fluorescent materials producing various colors cannot be introduced around the inorganic light emitting diode chip.

A cold cathode fluorescent lamps used in edge light type and direct light type backlight units has a structure wherein electrodes are formed at both ends of a fine glass tube having a diameter of several millimeters (mm), mercury and an inert gas (Ne or Ar) are sealed in the glass tube, and a fluorescent material is coated inside the glass tube. The cold cathode fluorescent lamp is different from general fluorescent lamps in terms of the shape of the internal electrodes. Bar-shaped electrodes were employed in the past, but cup-shaped electrodes with a maximized surface area are currently used in the cold cathode fluorescent lamp for improved light efficiency and luminance.

An external electrode fluorescent lamp as the light source used in the direct light type backlight unit has a structure similar to the cold cathode fluorescent lamp, except that no electrode exists inside the glass tube but electrodes are attached to the outside of the glass tube. Accordingly, the external electrode fluorescent lamp is advantageous in that shortening of life due to deterioration of the electrodes can be prevented, but has a problem that its luminance and efficiency vary depending on the length of the electrodes.

### SUMMARY OF THE INVENTION

Therefore, the present invention has been made in view of the above problems, and it is an object of the present invention to provide an edge light type and a direct light type backlight unit having good color purity and improved light efficiency which can be produced by using a novel diffusion sheet at reduced costs.

In order to accomplish the above objects of the present invention, there is provided a backlight unit for a liquid crystal display using a novel sheet. The backlight unit may be an edge, light type or direct light type unit The direction of light from a light source of the backlight unit may be unidirectional or bi-directional.

The sheet used in the backlight unit of the present invention absorbs a portion of light emitted from a light source of a blue wavelength or a mixed wavelength of a blue wavelength and at least one wavelength other than the blue wavelength, emits light at different wavelengths from the light emitted from the light source, and allows the rest of the light emitted from the light source to penetrate the sheet. The light excitation diffusion sheet is a film (a sheet) or plate (hereinafter, referred to simply as a “sheet”) produced by uniformly mixing a light-exciting material exciting and amplify the light emitted from the light source with a light-diffusing material scattering and diffusing the light emitted from the light source.

The light excitation-diffusion sheet of the present invention has a light guide function of changing a point or linear light source into a planar light source by adding a light-exciting material and scattering (material) particles to a light guide sheet, e.g., epoxy resin, maximizes the efficiency of light by exciting light from the light source, and improves the uniformity of light outgoing from the planar light source by light scattering.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view, schematically showing the structure of a conventional edge light type backlight unit;

FIG. 2 is a cross-sectional view schematically showing the structure of a conventional direct light type backlight unit;

FIGS. 3a to 3d are cross-sectional views schematically showing the structure of light excitation-diffusion sheets according to the present invention;

FIGS. 4a to 4c are cross-sectional views schematically showing the structure of edge light type backlight units using light excitation-diffusion sheets of the present invention;

FIGS. 5a and 5b are cross-sectional views schematically showing the structure of direct light type backlight units using light excitation-diffusion sheets of the present invention;

FIG. 6a is a cross-sectional view schematically showing the structure of a bidirectional edge light type backlight unit using a light excitation-diffusion sheet of the present invention, and FIG. 6b is a cross-sectional view schematically showing the structure of a bidirectional direct light type backlight unit using a light excitation-diffusion sheet of the present invention;

FIG. 7 is a graph comparing the spectrum of a backlight unit according to the present invention using a light excitation-diffusion sheet (YAG, DCJTB) and a blue inorganic light emitting diode as a light source, with that of a conventional backlight unit using a white inorganic light emitting diode as a light source;

FIG. 8 is a graph comparing the spectrum of a backlight unit of the present invention using a light excitation-diffusion sheet (YAG, ZnCdS) and a blue inorganic light emitting diode as a light source, with that of a conventional backlight unit using a white inorganic light emitting diode as a light source;

FIG. 9 is a graph comparing the spectrum of a backlight unit of the present invention using a light excitation-diffusion sheet (YAG) and a blue cold cathode fluorescent lamp as a light source, with that of a conventional backlight unit using a blue cold cathode fluorescent lamp as a light source.

### DESCRIPTION OF THE PREFERRED EMBODIMENTS

A light excitation-diffusion sheet of the present invention will now be described in more detail with reference to the accompanying drawings.

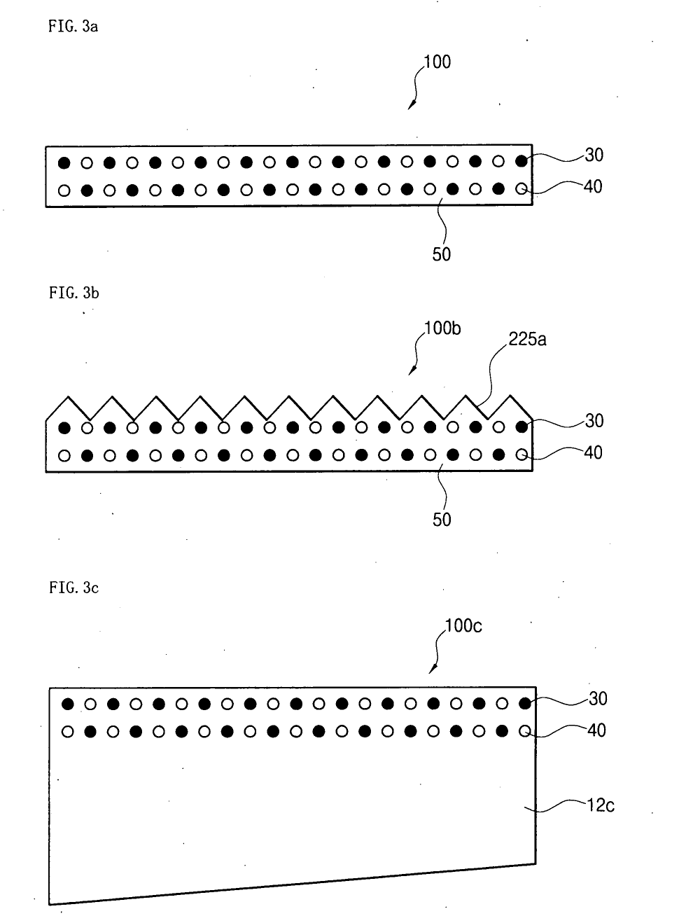

As shown in FIGS. 3a to 3d, light excitation-diffusion sheets 100, 100b, 100c and 100d are composed of a light-exciting material 30 for exciting and amplifying light, a light-diffusing material 40 for scattering and diffusing light, and-a resin 50 in a matrix form for uniformly distributing the light-exciting material and the light-diffusing material. In addition to these materials, a precipitation-preventing agent, a defoaming agent, a binder, or the like can be added in order to make the diffusion of the materials and particles uniform and to improve the moldability of the sheet during formation of the sheet.

Examples of the light-exciting material 30 used in the present invention include inorganic fluorescent materials, organic fluorescent materials, organic pigments, nanomaterials, etc. A representative light-exciting inorganic fluorescent material is a fluorescent material prepared by doping Y₃Al₅O₁₂ (YAG) as a gamet (Gd) material with cerium. Specific examples of inorganic fluorescent materials usable in the present invention include (Y_{1-x-y}GdₓCe_{y})₃(Al₁₋ₓGa_{z})₅O₁₂; (Gd₁₋ₓCeₓ)Sc₂Al₅O₁₂ (wherein x+y≦1; 0≦x≦1; 0≦y≦1; 0≦z≦1); SrB₄O₇:Sₘ²⁺; SrGa₂S₄:Eu²⁺; BaMg₂Al₁₆O₂₇:Eu²⁺; (Sr,Mg,Ca,Ba,Zn)₂P₂O₇:Eu,Mn; (Ca,Sr,Ba,Mg)₅(PO₄)₃(Cl,F,OH):Eu,Mn; (Sr,Ca,Ba,Mg)₁₀(PO₄)₆(F,Cl,Br,OH):Eu²⁺; (Sr,Ca,Ba,Mg)₁₀(PO₄)₆(F,Cl,Br,OH):Eu²⁺, Mn²⁺; (Sr,Ba,Ca)MgAl₁₀O₁₇:Eu,Mn; (Ba,Sr,Ca)MgAl₁₀O₁₇:Eu²⁺; (Sr,Ca)₁₀(PO₄)₆.nB₂O₃:Eu²⁺ (wherein 0<n<1) Sr₄Al₄O₂₅:Eu; 3.5 MgO.0.5 MgF₂.GeO₂:Mn⁴⁺; ZnS:Cu,Al; ZnS:Ag,Al; CaS:Ce; SrS:Ce; SrS:Eu; MgS:Eu; CaS:Eu; (Y,Tb,Lu,La,Gd)₃(Al,Sc,Ga,In)₅O₁₂:Ce,Pr,Sm; BaAl₈O₁₃:Eu; 2SrO.0.84P₂O₅.0.16B₂O₃:Eu; Sr₂Si₃O_{8.}2SrCl₂:Eu; Ba₃MgSi₂O₈:Eu²⁺; Sr₄Al₁₄O₂₅:Eu²⁺; (Ba,Sr,Cha)Al₂O₄:Eu²⁺; (Y,Gd,Lu,Sc,La)BO₃:Ce³⁺,Tb³⁺; (Ba,Sr,Ca)₂SiO₄:Eu²⁺; (Ba,Sr,Ca)₂(Mg,Zn)Si₂O₇:Eu²⁺; (Sr,Ca,Ba)(Al,Ga,In)₂S₄:Eu²⁺; (Y,Gd,Tb,La,Sm,Pr,Lu)ₓ(Al,Ga,In)_{y}O₁₂:Ce³⁺ (wherein 2.8≦x≦3; 4.9≦y≦_{5.1}); (Ca,Sr,Ba)₈(Mg,Zn)(SiO₄)₄(Cl,F)₂:Eu²⁺,Mn²⁺; (Gd,Y,Lu,La)₂O₃:Eu³⁺, Bi³⁺; (Gd,Y,Lu,La)₂O₂S:Eu³⁺,Bi³⁺; (Gd,Y,Lu,La)VO₄:Eu³⁺,Bi³⁺; SrY₂S₄:Eu²⁺; CaLa₂S₄:Ce²⁺; (Ba,Sr,Ca)MgP₂O₇:Eu²⁺,Mn²⁺; ZnCdS; and mixtures thereof. These light-exciting materials have different main emission wavelengths. Ce³⁺ light emission dependent on a garnet composition can vary from green light (˜540 nm; YAG:Ga,Ce) to red light (˜600 nm; YAG:Gd,Ce) without a decrease in light efficiency. In addition, a representative inorganic fluorescent material for deep red light emission is SrB₄O₇:Sm²⁺. SM²⁺ mainly contributes to red light emission. Deep red inorganic fluorescent materials absorb all visible rays at 600 nm or less and emit deep red light at 650 nm or more. A representative inorganic fluorescent material for green light emission is SrGa₂S₄:Eu²⁺. Green inorganic fluorescent materials absorb light at 500 nm or less, and emit light at a main wavelength of 535 nm. A representative inorganic fluorescent material for blue light emission is BaMg2Al16O27:Eu²⁺. Blue inorganic fluorescent materials absorb light at 430 nm or less, and emit light at a main wavelength of 450 nm.

Organic fluorescent materials can also emit blue, green or red light For example, representative organic materials for blue light emission are (4,4′-bis(2,2-diphenyl-ethen-1-yl)diphenyl (DPVBi), bis(styryl)amine (DSA)-based materials, etc. Representative organic materials for green light emission are tris(8-quinolinato)aluminum (III)(Alq₃), coumarin 6,10-(2-benzothiazolyl)-1,1,7,7-tetramethyl-2,3,6,7-tetrahydro-1 H ,5 H ,11 H-[1]benzopyrano[6,7,8-ij]-quinoliin-11-one (C545T), quinacrydone, etc. Representative organic materials for red light emission are 4-dicyanomethylene-2-methyl-6-(julolidin-4-yl-vinyl)-4H-pyrane (DCM2), 4-(dicyanomethylene)-2-methyl-6-(1,1,7,7-tetramethyljulolidyl-9-enyl)-4H-pyrane (DCJT), 4-(dicyanomethylene)-2-t-butyl-6-(1,1,7,7-tetramethyljulolidyl-9-enyl)-4H-pyrane (DCJTB), and the like.

Examples of organic pigments usable in the present invention include azo-based pigments, e.g., insoluble azo pigments, azo lake pigments, condensed azo pigments and chelated azo pigments; phthalocyne-based pigments, e.g., copper phthalocyanines, halogenated copper phthalocyanines, metal-free phthalocyanines and copper phthalocyanine lake pigments; dye lake pigments, e.g., acidic dye lake pigments and basic dye lake pigments; condensed polycyclic pigments, e.g., anthraquinone, thioindigo, perylene, perinone, quinacridone, dioxazine, isoindolinone, isoindoline and quinaplhaalone; and other pigments, e.g., nitroso pigments, alizarin, azomethine metal complexes, aniline black, allcai blue and flame fluorescent materials.

As materials for nanometals and composite quantum dots, nano-sized metals and nanocomposite materials can be used. As the nanometals, there can be used, for example, platinum, gold, silver, nickel, magnesium, and palladium. As the nanocomposite materials, there can be mentioned cadmium sulfide (CdS), cadmium selenide (CdSe), zinc sulfide (ZnS), zinc selenide (ZnSe), indium phosphite (InP), titanium oxide (TiO₂), zinc oxide (ZnO), tin oxide (SnO), silicon oxide (SiO₂), magnesium oxide (MgO), and others.

The light-diffusing material 40 having a function of uniformly diffusing light is largely divided into a parent-diffusing agent and a white diffusing agent. Examples of transparent diffusing agents include organic transparent diffusing agents, such as acryl, stylene and silicone resins, and inorganic transparent diffusing agents, such as synthetic silica, glass bead and diamond. Representative examples of white diffusing agents include organic oxides, such as silicon oxide (SiO₂), titanium oxide (TiO₂), zinc oxide (ZnO), barium sulfate (BaSO₄), calcium carbonate (CaSO₄), magnesium carbonate (MgCO₃), aluminum hydroxide (Al(OH)₃) and clay.

Examples of the resin 50 acting as a matrix for the light-exciting material 30 and the light-diffusing material 40 include epoxy, urethane, acryl, PET, polyvinyl chloride, polyester, polycarbonate, vinyl, methacrylic ester, polyamide, synthetic rubber, polystyrene, CBS, polymethylmethacrylate, fluorine, polyethylene, polypropylene, ABS, and others.

In addition, a precipitation-preventing agent for preventing the light-exciting material 30 and the light-diffusing material 40 from being precipitated, a defoaming agent for preventing the formation of foams, a binder, and the like, may be added during formation of a uniform film using the light-exciting material 30, the light-diffusing material 40 and the resin 50.

The production of the light excitation-diffusion sheets 100, 100b, 110c and 100d from these materials is performed by known techniques, for example, molding, extrusion, exclusion, suspension printing, hot roll coating, heat plate coating, cold coating, screen printing, dip coating, spray coating, spin coating, doctor blade, extrusion molding, transfer, lamination, injection molding, blow molding, calendering, casting, FRP molding, heat molding, welding, and other techniques. Of these, extrusion molding and screen printing are preferred.

The light excitation-diffusion sheet of the present invention is produced in accordance with the following procedure. First, the synthetic resin 50 is melted. The light-exciting material 30, the light-diffusing material 30, the precipitation-preventing agent, the defoaming agent and the binder are added to the molten synthetic resin. Thereafter, the mixture is uniformly stirred. Rapid cooling in a molten state lowers the degree of crystallization of the mixture to produce a film having superior moldability. The appearance of the film, i.e. degree of crystallization, crystal size and crystal structure, has a great influence on the properties of the film. The strength, impermeability and chemical resistance of the film are determined by the crystal on rate. The toughness and flexibility of the film are determined by the amorphous section of the film. Slow cooling in a molten state enables the production of a highly crystaline film. The film thus produced has a low ductility, but has superior impermeability and excellent strength. Post-processing affects the degree of cure of the film, for example, heat molding or stetching can improve the degree of crystallization of the film.

Extrusion molding using a mold leads to a functional film. That is, when one side face of the sheet 100b is formed in the shape of a sawtooth 225a, as shown in FIG. 3b, the sheet 111b further has a prism function, in addition to excitation and diffusion functions. As shown in FIG. 3c, when the light-exciting material 30 and the light-diffusing material 40 are distributed only at the upper side of the sheet 100c and the lower side 12c is produced in the form of a light guide sheet, the sheet 100c has a light guide function, in addition to excitation and diffusion functions. In particular, since the sheet 100d shown in FIG. 3d can further have light guide and prism functions, a backlight unit having better color purity can be produced at reduced costs using only one prism sheet.

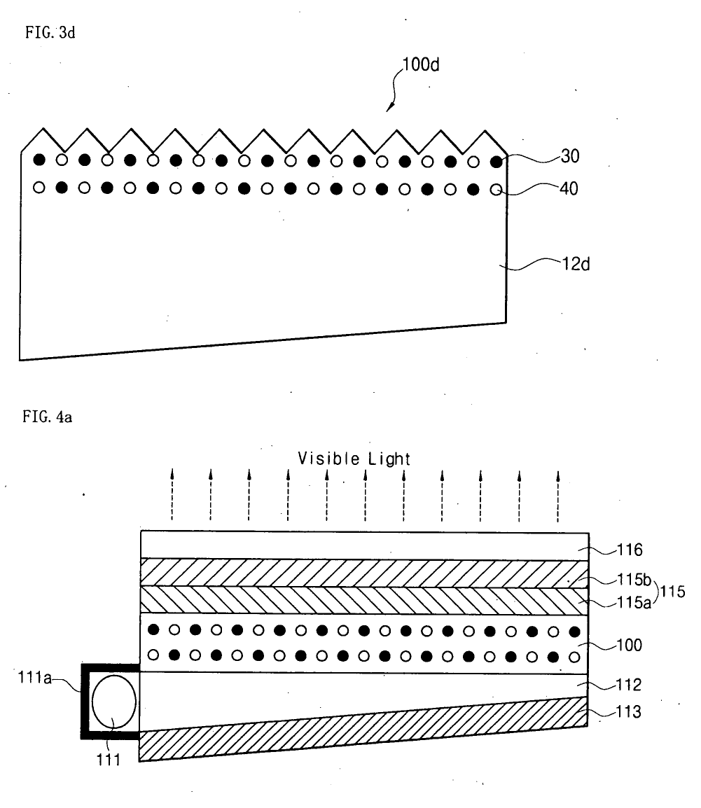

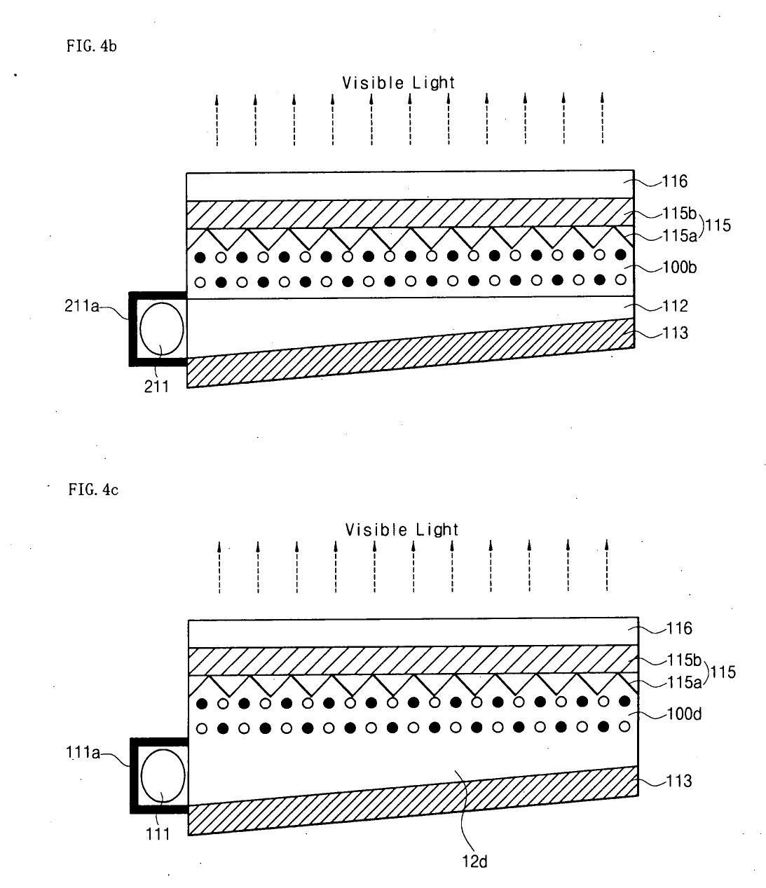

Detailed description will be made of embodiments of a backlight unit for a liquid crystal display according to the present invention using the light excitation-diffusion sheet. FIG. 4a shows an edge light type backlight unit Referring to FIG. 4a, a blue inorganic light emitting diode is used as a point light source 111, or a cold cathode fluorescent lamp is used as a linear light source 111. Light emitted from the light source 111 is guided by a light guide sheet 112 to convert the light into light emitted from a planar light source, or a portion of the emitted light is reflected from a reflection plate 113 to enter a light excitation-diffusion sheet 100. A portion of blue light entering the light excitation-diffusion sheet 100 penetrates through the sheet 100, and the rest is converted to light of various colors, including blue, yellow and red, by the light-exciting material present in the light excitation-diffusion sheet 100 and is simultaneously amplified. In addition, the amplified light is scattered and diffused by the light-diffusing material present in the light excitation-diffusion sheet 100, thereby improving the uniformity of the light The light escaping from the light excitation-diffusion sheet 100 is white light having good color purity. After the scattered and diffused light arrives at horizontal and perpendicular prism sheets 115 via the light excitation-diffusion sheet 100, it is refracted and collected in the prism sheets 115, resulting in improved luminance. In this manner, the collected light is introduced into a liquid crystal display via a protective sheet 116.

The light excitation-diffusion sheet shown in FIG. 4a can be replaced with the sheet 110b shown in FIG. 3b. FIG. 4b shows the structure of a backlight unit employing the light excitation-diffusion sheet 100b. According to this embodiment, since the light excitation-diffusion sheet 100b acts as a prism, the horizontal prism 115a becomes unnecessary. Further, the light excitation-diffusion sheet shown in FIG. 4a can be replaced with the light excitation-diffusion sheet 100c or 100d shown in FIG. 3c or 3d. Since the light excitation-diffusion sheets 100c and 100d have a light guide function, the light guide sheet 112 shown in FIG. 4a or 4b becomes unnecessary. Moreover, since the light excitation-diffusion sheet 100d employed in the backlight unit shown in FIG. 4c has light guide and prism functions, the necessity of the horizontal prism 115a shown in FIG. 4a is removed.

To obtain the spectrum of the backlight unit shown in FIG. 4a, the light excitation-diffusion sheet 100 was produced in accordance with the following procedure.

Production of Light Excitation-Diffusion Sheet

7% by weight of silicon oxide balls, 4.99% by weight of YAG and 0.01% by weight of 4-(dicyanomethylene)-2-t-butyl-6-(1,1,7,7-tetramethyljulolidyl-9-enyl)-4H-pyrane (DCJTB) were mixed with 88% by weight of an epoxy resin, and were further mixed in an ultrasonic washing machine at room temperature for about 20 minutes. The resulting solution was uniformly applied to a caster on which a release agent had been coated, and then the balance of the caster was maintained at a constant level using a level equalizer. After the solution was allowed to stand for about 10 minutes, it was hardened on a hot plate at about 125° C. for one hour, left to stand at room temperature for about 30 minutes, re-hardened in an oven at 125° C. for 3 hours, and peeled off to produce a light excitation-diffusion sheet.

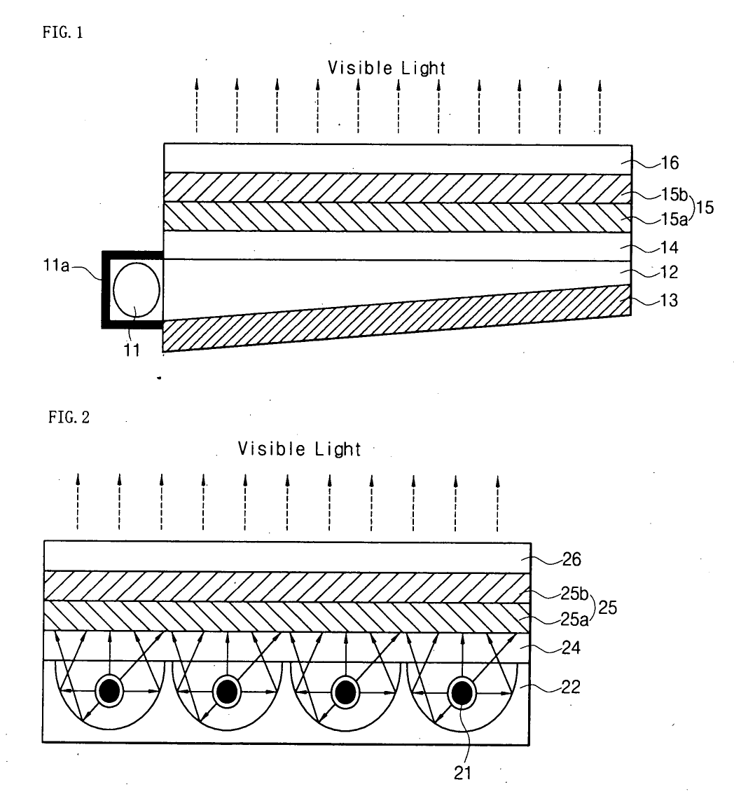

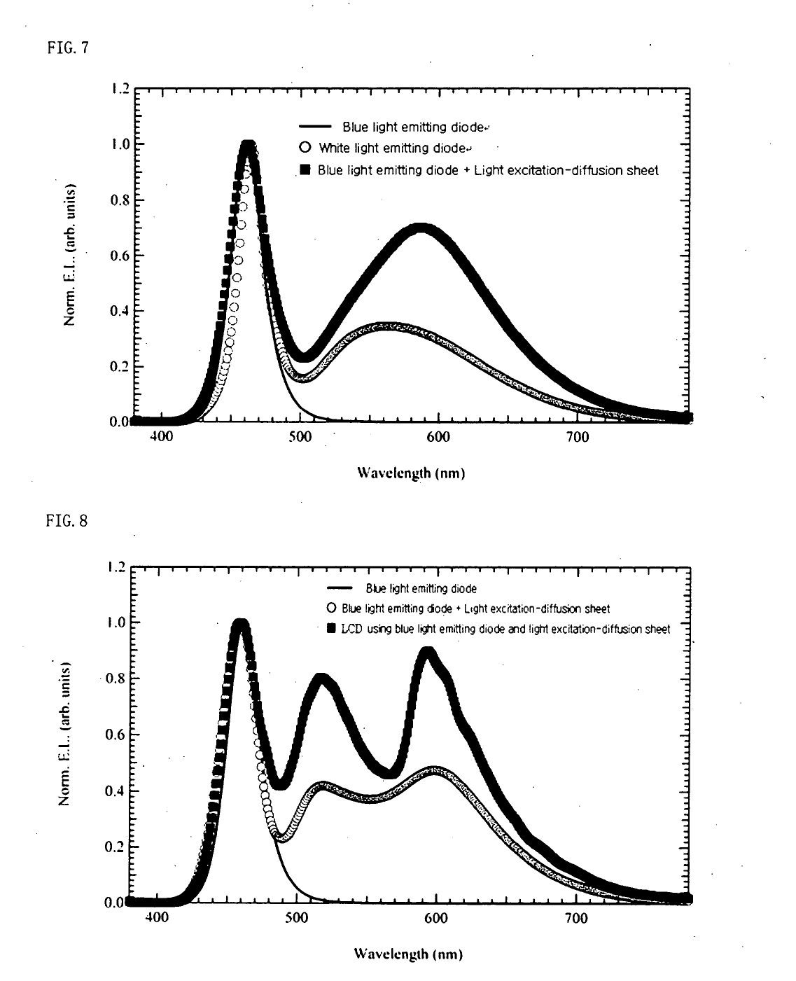

FIG. 7 is a graph comparing the spectrum of the backlight unit shown in FIG. 4a according to the present invention using a blue inorganic light emitting diode as a light source, with that of the conventional backlight unit shown in FIG. 1 using a white inorganic light emitting diode as a light source. (CS-1000A, manufactured by Minolta) The-conventional backlight unit uses the complementary light at main wavelengths of about 460 nm and about 560 nm. The backlight unit of the present invention had main wavelengths of 460 nm and 590 nm, and contained more light of green and red colors than the conventional backlight unit, showing improved color reproducibility.

A great deal of research has been conducted to improve the color reproducibility of backlight units. However, an increase in the output of an inorganic light emitting diode results in deterioration of a fluorescent material distributed in a molding part Accordingly, it is difficult to introduce a fluorescent material of various colors around the inorganic light emitting diode chip. Since the light excitation-diffusion sheet of the present invention is configured in such a way that it is separated from the light source, the problem can be solved. This fact is evident by the spectral results (FIG. 7) of the backlight unit according to the present invention.

FIG. 8 shows the spectrum of the backlight unit shown in FIG. 4a according to the present invention in which the light excitation-diffusion sheet is produced using 4% YAG and 1% ZnCdS and the inorganic fluorescent material (ZnCdS) is used as a red colorant instead of the organic fluorescent material (DCJTB) used in the light excitation-diffusion sheet shown in FIG. 7. The YAG predominantly emits green light, and ZnCdS emits red light The spectrum shows that the backlight unit of the present invention emits three-wavelength white light of about 460 nm (blue), about 520 nm (green), and about 600 nm (red). The spectral results shown in FIG. 8 indicate that the backlight unit according to the present invention has no problem in the light emission from not only the organic fluorescent material but also the inorganic fluorescent material.

As can be seen from the results shown in FIGS. 7 and 8, the light excitation diffusion sheets of the present invention can solve the problem of conventional backlight units, i.e. difficult introduction of a fluorescent material producing various colors due to the danger of deterioration of the fluorescent material. In addition, the light excitation diffusion sheet of the present invention can solve the problems of conventional backlight units and thus a high color reproducibility can be realized. As apparent from the spectrum of a liquid crystal display in which the light excitation diffusion sheet of the present invention is used (see, black squares shown in FIG. 8), the liquid crystal display emits light at blue, green and red wavelengths at a uniform level, indicating a high color reproducibility.

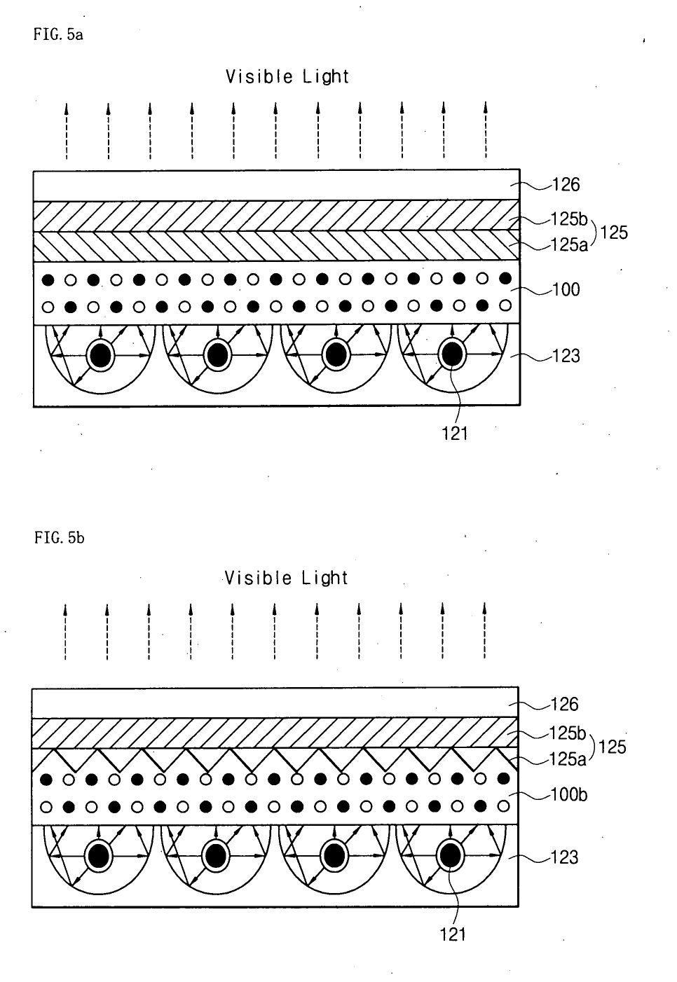

FIGS. 5a and 5b show the structure of backlight units using direct light type light sources 121. Light emitted from the light sources 121 (cold cathode fluorescent lamps or external electrode fluorescent lamps) directly arrives at the light excitation-diffusion sheet 100 or 100b, or a portion of the light is reflected from a reflection sheet 123 and then reaches the light excitation-diffusion sheet 100 or 100b. A portion of the light entering the light excitation diffusion sheet 100 or 100b penetrates through the sheet 100 or 100b, and the rest of the light is converted to light of various colors, including blue, green, yellow and red, by a light-exciting material present in the light excitation-diffusion sheet 100 or 100b and is simultaneously amplified. In addition, the amplified light is scattered and diffused by a light-diffusing material present inside the light excitation-diffusion sheet 100 or 100b, thereby improving the uniformity of the light The light escaping from the light excitation-diffusion sheet 100 or 100b is white light having good color purity. After the scattered and diffused light arrives at horizontal and perpendicular prism sheets 125 via the light excitation-diffusion sheet 100 or 100b, it is refracted and collected in the prism sheets 125, resulting in improved luminance. In this manner, the collected light is introduced into a liquid crystal display via a protective sheet 126.

To obtain the spectrum of the backlight unit shown in FIG. 5b, the light excitation-diffusion sheet 100b was produced in the same manner as the production of the light excitation-diffusion sheet shown in FIG. 3b.

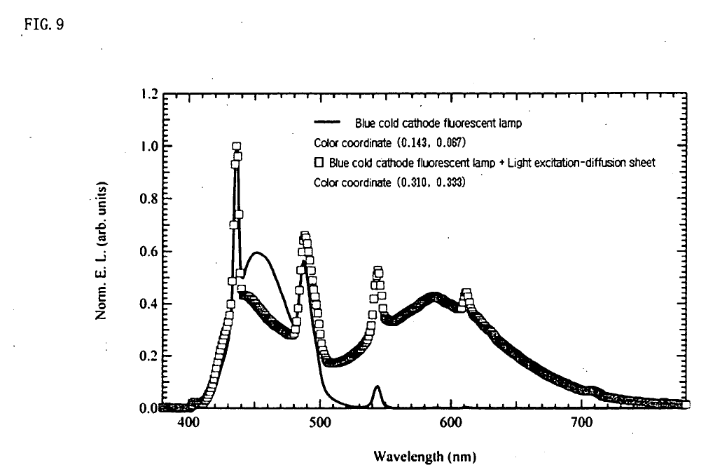

FIG. 9 is a graph comparing the spectrum of the backlight unit shown in FIG. 5 according to the present invention using a blue cold cathode fluorescent lamp as a light source, with that of the conventional backlight unit shown in FIG. 2 using a blue cold cathode fluorescent lamp as a light source. The light excitation-diffusion sheet used in the backlight unit (FIG. 5b) of the present invention was produced from 94% of a synthetic epoxy resin, 5% of YAG as a light-exciting material, 1% of silicon oxide balls as light-diffusing materials. As can be seen from FIG. 9, blue light is converted to green light and red light through the light excitation-diffusion sheet 100b of FIG. 5b, and then the converted green light and red light are combined with each other to emit white light The spectrum of the backlight unit using the light excitation-diffusion sheet and employing a blue cold cathode fluorescent lamp as a light source shows that the backlight unit emits three-wavelength white light of about 445 nm (blue), about 540 nm (green), and about 610 nm (red), and thus the light has good color reproducibility.

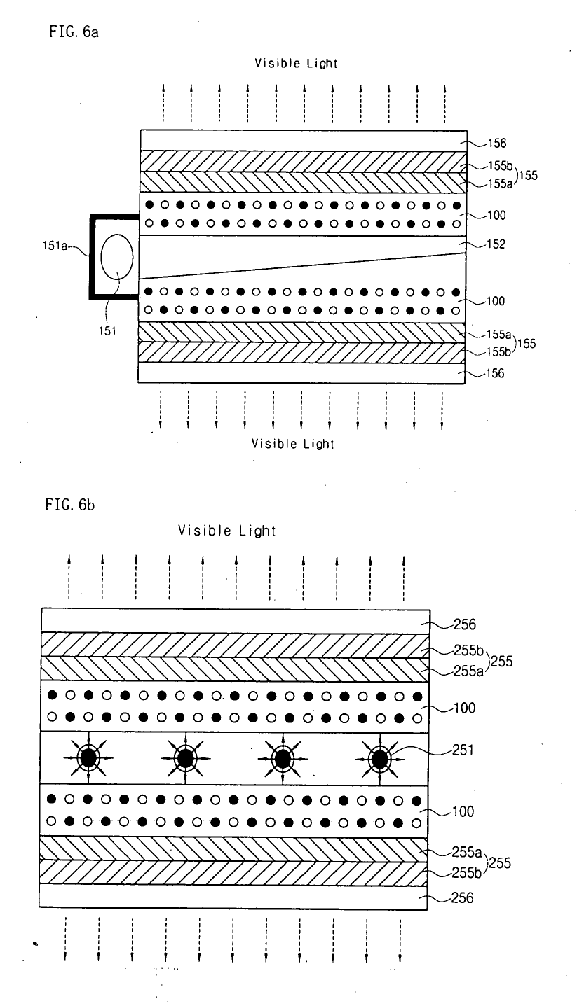

The backlight units described above are unidirectional backlight units. In contrast, the structure of bi-directional backlight units is schematically shown in FIGS. 6a and 6b. As shown in FIG. 6a, the bidirectional backlight unit comprises: an edge light type light source 151; a light guide sheet 152 for guiding light emitted from the light source 151; and light excitation-diffusion sheets 100, prism sheets 155, and protective sheets 156 symmetrically layered in this order on the upper surface and lower surface of the light guide sheet 152, respectively. In addition, one or two partial-reflection sheets (not shown) may be disposed at either one side or both sides of the light guide sheet 152 to reflect a portion of the light guided by the light guide sheet 152 and to transmit the remainder of the guided light.

As shown in FIG. 6b, the bi-directional backlight unit comprises: a plurality of direct light type light sources 151; and light excitation diffusion sheets 100, pairs of prism sheets 255, and protective sheets 156 symmetrically layered in this order over and under the light sources 251, respectively. Like the backlight unit shown in FIG. 6a, one or two partial-reflection sheets (not shown) may be disposed at either one side or both sides of the light sources 251 to reflect a portion of the light emitted from the light sources 251 and to transmit the remainder of the emitted light.

The upper and lower light excitation-diffusion sheets 100 may have structures different from each other.

As apparent from the above description, the present invention provides the following effects.

First, the use of the light excitation-diffusion sheet according to the present invention in an edge light type backlight unit, instead of a conventional diffusion sheet, leads to a reduction in production costs.

Secondly, due to the use of the light excitation-diffusion sheet according to the present invention in a direct light type backlight unit, instead of a conventional diffusion sheet, simultaneous light excitation and diffusion are possible, power consumption required to obtain a given luminance is lowered and operation circuits of a light source are simplified. In addition, since the low power consumption contributes to the simplification of integration circuits for a liquid crystal display, manufacturing costs of the liquid crystal display can be reduced.

Thirdly, since the light excitation-diffusion sheet of the present invention further has a prism function through a surface modification, a backlight unit can be produced using simple production processes at low costs.

Finally, suitable selection of light-exciting materials used to produce the light excitation-diffusion sheet of the present invention makes it possible to create light of wavelengths and colors corresponding to the needs of consumers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed as deserving the protection of Letters Patent is:

1. A light excitation-diffusion sheet for a backlight unit adapted to absorb a portion of light emitted from a light source of a blue wavelength or a mixed wavelength of a blue wavelength and at least one wavelength other than the blue wavelength, to emit light at different wavelengths from the light emitted from the light source, and to allow the rest of the light emitted from the light source to penetrate the sheet,
wherein the light excitation-diffusion sheet comprises a light-exciting material exciting and amplifying the light emitted from the light source, and a light-diffusing material scattering and diffusing the light emitted from the light source, the light-exciting material and the light-diffusing material being uniformly distributed in the light excitation-diffusion sheet.

2. A backlight unit for a liquid crystal display, comprising: an edge light type light source of a blue wavelength or a mixed wavelength of a blue wavelength and at least one wavelength other than the blue wavelength; a light guide sheet for guiding light emitted from the light source; a reflection sheet disposed under the light guide sheet; a light excitation-diffusion sheet disposed on the light guide sheet; two prism sheets disposed on the light excitation-diffusion sheet in directions perpendicular and parallel to the light excitation-diffusion sheet, respectively; and a protective sheet disposed on the prism sheets,
wherein the light excitation-diffusion sheet is adapted to absorb a portion of light emitted from the light source, to emit light at different wavelengths from the light emitted from the light source and to allow the rest of the light emitted from the light source to penetrate the sheet, and the light excitation-diffusion sheet is produced by uniformly mixing a light-exciting material exciting and amplifying the light emitted from the light source with a light-diffusing material scattering and diffusing the light emitted from the light source.

3. A backlight unit for a liquid crystal display, comprising: an edge light type light source of a blue wavelength or a mixed wavelength of a blue wavelength and at least one wavelength other than the blue wavelength; a light excitation-diffusion sheet adapted to guide light emitted from the light source, to absorb a portion of the guided light, to emit light at different wavelengths from the light emitted from the light source, and to allow the rest of the light emitted from the light source to penetrate the sheet; two prism sheets disposed on the light excitation-diffusion sheet in directions perpendicular and parallel to the light excitation-diffusion sheet, respectively; and a protective sheet disposed on the prism sheets,
wherein the light excitation-diffusion sheet includes a light guide part having a bottom surface inclined upwardly toward a side opposed to the light source, and a part formed on the light guide part and packed with a light-exciting material exciting and amplifying the light emitted from the light source and a light-diffusing material scattering and diffusing the light emitted from the light source.

4. A backlight unit for a liquid crystal display, comprising: an edge light type light source of a blue wavelength or a mixed wavelength of a blue wavelength and at least one wavelength other than the blue wavelength; a light guide sheet for guiding light emitted from the light source; a reflection sheet disposed under the light guide sheet; a light excitation-diffusion sheet disposed on the light guide sheet; a prism sheet disposed on the light excitation-diffusion sheet in a direction perpendicular to the light excitation-diffusion sheet; and a protective sheet disposed on the prism sheet,
wherein the light excitation-diffusion sheet is adapted to absorb a portion of light emitted from the light source, to emit light at different wavelengths from the light emitted from the light source and to allow the rest of the light emitted from the light source to penetrate the sheet, the light excitation-diffusion sheet is produced by uniformly mixing a light-exciting material exciting and amplifying the light emitted from the light source with a light-diffusing material scattering and diffusing the light emitted from the light source, and the light excitation-diffusion sheet has an upper surface in the shape of a sawtooth facing the prism sheet.

5. A backlight unit for a liquid crystal display, comprising: an edge light type light source of a blue wavelength or a mixed wavelength of a blue wavelength and at least one wavelength other than the blue wavelength; a light excitation-diffusion sheet adapted to guide light emitted from the light source, to absorb a portion of the guided light, to emit light at different wavelengths from the light emitted from the light source, and to allow the rest of the light emitted from the light source to penetrate the sheet; a prism sheet disposed on the light excitation-diffusion sheet in a direction perpendicular to the light excitation-diffusion sheet; and a protective sheet disposed on the prism sheet,
wherein the light excitation-diffusion sheet includes a light guide part having a bottom surface inclined upwardly toward a side opposed to the light source, and a part formed on the light guide part and packed with a light-exciting material exciting and amplifying the light emitted from the light source and a light-diffusing material scattering and diffusing the light emitted from the light source; and the light excitation-diffusion sheet has an upper surface in the shape of a sawtooth facing the prism sheet

6. A backlight unit for a liquid crystal display, comprising: a plurality of direct light type light sources of a blue wavelength or a mixed wavelength of a blue wavelength and at least one wavelength other than the blue wavelength; a reflection sheet disposed below the light sources; a light excitation-diffusion sheet disposed over the light sources; two prism sheets disposed on the light excitation-diffusion sheet in directions perpendicular and parallel to the light excitation-diffusion sheet, respectively; and a protective sheet disposed on the prism sheets,
wherein the light excitation-diffusion sheet is adapted to absorb a portion of light emitted from the light sources, to emit light at different wavelengths from the light emitted from the light sources and to allow the rest of the light emitted from the light sources to penetrate the sheet, and the light excitation-diffusion sheet is produced by uniformly mixing a light-exciting material exciting and amplifying the light emitted from the light sources with a light diffusing material scattering and diffusing the light emitted from the light sources.

7. A backlight unit for a liquid crystal display, comprising: a plurality of direct light type light sources of a blue wavelength or a mixed wavelength of a blue wavelength and at least one wavelength other than the blue wavelength; a reflection sheet disposed below the light sources; a light excitation-diffusion sheet disposed over the light sources; a prism sheet disposed on the light excitation-diffusion sheet in a direction perpendicular to the light excitation-diffusion sheet; and a protective sheet disposed on the prism sheet,
wherein the light excitation-diffusion sheet is adapted to absorb a portion of light emitted from the light sources, to emit light at different wavelengths from the light emitted from the light sources and to allow the rest of the light emitted from the light sources to penetrate the sheet, the light excitation-diffusion sheet is produced by uniformly mixing a light-exciting material exciting and amplifying the light emitted from the light sources with a light-diffusing material scattering and diffusing the light emitted from the light sources, and the light excitation-diffusion sheet has an upper surface in the shape of a sawtooth facing the prism sheet.

8. A bi-directional backlight unit for a liquid crystal display, comprising: an edge light type light source of a blue wavelength or a mixed wavelength of a blue wavelength and at least one wavelength other than the blue wavelength; a light guide sheet for guiding light emitted from the light source; and light excitation-diffusion sheets, pairs of horizontal and vertical prism sheets, and protective sheets symmetrically layered in this order on the upper surface and lower surface of the light guide sheet, respectively,
wherein each of the light excitation-diffusion sheets is adapted to absorb a portion of light emitted from the light source, to emit light at different wavelengths from the light emitted from the light source and to allow the rest of the light emitted from the light source to penetrate the sheet, and the light excitation-diffusion sheet is produced by uniformly mixing a light-exciting material exciting and amplifying the light emitted from the light source with a light-diffusing material scattering and diffusing the light emitted from the light source.

9. A bi-directional backlight unit for a liquid crystal display, comprising: an edge light type light source of a blue wavelength or a mixed wavelength of a blue wavelength and at least one wavelength other than the blue wavelength; a light guide sheet for guiding light emitted from the light source; and light excitation-diffusion sheets, vertical prism sheets, and protective sheets symmetrically layered in this order on the upper surface and lower surface of the light guide sheet, respectively,
wherein each of the light excitation-diffusion sheets is adapted to absorb a portion of light emitted from the light source, to emit light at different wavelengths from the light emitted from the light source and to allow the rest of the light emitted from the light source to penetrate the sheet, the light excitation-diffusion sheet is produced by uniformly mixing a light-exciting material exciting and amplifying the light emitted from the light source with a light-diffusing material scattering and diffusing the light emitted from the light source, and the light excitation-diffusion sheet has an upper surface in the shape of a sawtooth facing the prism sheet

10. A bidirectional backlight unit for a liquid crystal display, comprising: a plurality of direct light type light sources of a blue wavelength or a mixed wavelength of a blue wavelength and at least one wavelength other than the blue wavelength; and light excitation-diffusion sheets, pairs of horizontal and vertical prism sheets, and protective sheets symmetrically layered in this order over and under the light sources, respectively,
wherein each of the light excitation-diffusion sheet is adapted to absorb a portion of light emitted from the light sources, to emit light at different wavelengths from the light emitted from the light sources and to allow the rest of the light emitted from the light sources to penetrate the sheet, and the light excitation-diffusion sheet is produced by uniformly mixing a light-exciting material exciting and amplifying the light emitted from the light sources with a light-diffusing material scattering and diffusing the light emitted from the light sources.

11. A bi-directional backlight unit for a liquid crystal display, comprising: a plurality of direct light type light sources of a blue wavelength or a mixed wavelength of a blue wavelength and at least one wavelength other than the blue wavelength; and light excitation-diffusion sheets, vertical prism sheets, and protective sheets symmetrically layered in this order over and under the light sources, respectively,
wherein each of the light excitation-diffusion sheets is adapted to absorb a portion of light emitted from the light sources, to emit light at different wavelengths from the light emitted from the light sources and to allow the rest of the light emitted from the light sources to penetrate the sheet, the light excitation-diffusion sheet is produced by uniformly mixing a light-exciting material exciting and amplifying the light emitted from the light sources with a light-diffusing material scattering and diffusing the light emitted from the light sources, and the light excitation-diffusion sheet has an upper surface in the shape of a sawtooth facing the prism sheet.
